(19) United States
(12) Patent Application Publication
(10) Pub. No.: US 2016/0001528 A1
(43) Pub. Date: Jan. 7, 2016

(54) ELECTRICAL COMPONENT

(71) Applicant: DENSO CORPORATION, Kariya-city (JP)

(72) Inventors: Akira TAKAKURA, Nagoya (JP); Hiroyuki OKUHIRA, Kariya-shi (JP)

(21) Appl. No.: 14/789,170

(22) Filed: Jul. 1, 2015

(30) Foreign Application Priority Data
Jul. 1, 2014 (JP) 2014-135864

(51) Int. Cl. B32B 27/06; B32B 27/28; B32B 27/38

(52) U.S. Cl. CPC B32B 27/06; B32B 27/38; B32B 27/281; B32B 2250/02; B32B 2255/26; B32B 2457/00

(57) ABSTRACT

An electrical component has an electronic part, a primer layer covering at least partially the electronic part, and a sealing resin covering at least partially the electronic part and the primer layer. The primer layer contains a polyimide polymer having the structure represented by the following chemical formula (1), and the sealing resin contains an epoxy-based resin and/or maleimide-based resin.

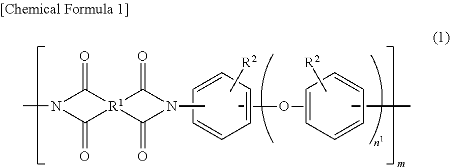

(In the formula (1), R¹ is a tetravalent alicyclic hydrocarbon group, tetravalent aliphatic hydrocarbon group, or tetravalent aromatic hydrocarbon group, and may contain O or/and S. In the formula (1), R² is H or 1-3C alkyl group. In the formula (1), n¹ is an integer from 1 to 10 (inclusive), and m is an integer from 1 to 100000 (inclusive).)

### CROSS-REFERENCE TO RELATED APPLICATION

This application is based on and claims the benefit of priority from earlier Japanese Patent Application No. 2014-135864 filed on Jul. 1, 2014, the description of which is incorporated herein by reference.

### BACKGROUND

1. Technical Field

This disclosure relates to an electrical component having an electronic part, and specifically relates to packaging material of the electronic part.

2. Related Art

In order to protect electronic parts from external environments such as impact, pressure, humidity, or the like, sealing resins are provided in electrical components. Conventionally, for example, a circuit board using a copper-clad laminate has been suggested. The copper-clad laminate has a primer resin layer and a polyimide layer formed thereon, the primer resin layer being formed on a surface of a covering layer provided on copper foil.

However, the conventional electrical component does not have enough affinity between the sealing resin and the electronic part. Accordingly, if the electrical component is used in a wide temperature range, peeling might occur between the sealing resin and the electronic part.

### CITATION LIST

### Patent Literature

Patent Literature 1: JP-A-2012-76363

### SUMMARY

For solving the problems, this disclosure has an object to provide an electrical component having excellent durability, which can ensure use in a wide temperature range (for example, −40° C. to 250° C.).

An embodiment of this disclosure is an electrical component having an electronic part, a primer layer covering at least partially the electronic part, and a sealing resin covering at least partially the electronic part and the primer layer. The primer layer contains polyimide polymer having the structure represented by the following chemical formula (1), and the sealing resin contains epoxy-based resin and/or maleimide-based resin.

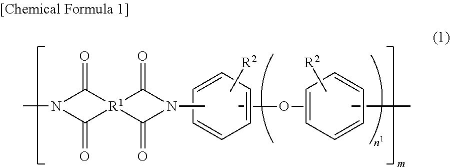

(In the formula (1), R¹ is a tetravalent alicyclic hydrocarbon group, tetravalent aliphatic hydrocarbon group, or tetravalent aromatic hydrocarbon group, and may contain O or/and S. In the formula (1), R² is H or 1-3C alkyl group. In the formula (1), n¹ is an integer from 1 to 10 (inclusive), and m is an integer from 1 to 100000 (inclusive).)

### BRIEF DESCRIPTION OF THE DRAWINGS

In the accompanying drawings:

FIG. 1 is a cross-sectional view of an electrical component of Example 1; and

FIG. 2 is a chart showing result of thermal analysis of the diamine compound in Example 1.

### DETAILED DESCRIPTION OF PREFERRED EMBODIMENTS

Now is described an embodiment of the electrical component of this disclosure.

The electronic part is preferred to have a power element having an SiC substrate and the like. The power element may be exposed to a high temperature environment, for example, over 240° C. Using the SiC substrate makes the electrical component show noteworthy durability over a wide temperature range. The electrical component can include, for example, a semiconductor module (a power card) and the like used in a power control unit (PCU) for a vehicle, especially a hybrid vehicle (HV).

Sealing resin containing an epoxy-based resin and/or a maleimide-based resin is made of, for example, a cured product of a molding material which contains a curing agent and a base resin containing an epoxy compound and/or a maleimide compound. As the curing agent, for example, an amine-based curing agent, a phenol-based curing agent and the like can be used. As a general relation between a base resin and a curing agent, it is preferred that the base resin contains at least two or more functional groups in a molecule. That is, the base resin containing a maleimide compound and/or an epoxy compound is preferred to have two or more functional groups in total of epoxy groups and/or maleimide groups. The maleimide compound and the epoxy compound are prepolymers which react with the curing agent to become polymers, for example, monomers.

The formulation ratio of the base resin and the curing agent can be adjusted properly to a general relation between a base resin and a curing agent, depending on the equivalence ratio of functional groups of the base resin and the curing agent. Specifically, the formulation ratio can be adjusted such that the equivalence ratio of the functional groups of the base resin and the curing agent is within a range of 0.5 to 1.5 (inclusive), preferably 0.8 to 1.2 (inclusive), and more preferably 0.9 to 1.1 (inclusive) respectively.

In the molding material, the ratio (N_{M}+N_{E})/(N_{A}+N_{H}) of the sum (the sum of the number N_{M} of the maleimide groups and the number N_{E} of the epoxy groups) of the number of the functional groups contained in the base resin and the sum (the sum of the number N_{A} of amino groups and the number N_{H} of hydroxyl groups) of the number of the functional groups contained in the curing agent is preferred to be within a range of 0.9 to 1.1 (inclusive) respectively. It is most preferable that the ratio (N_{M}+N_{E})/(N_{A}+N_{H}) of the sum of the number of the functional groups contained in the base resin and the sum of the number of the functional groups contained in curing agent, i.e. the equivalence ratio, is 1.

The maleimide compound is preferred to have two or more maleimide groups in a molecule. In this case, the maleimide compound can cross-link without using other materials. As the maleimide compound, there can be used, for example, a bismaleimide compound which is bifunctional, such as 4,4-diphenylmethane bismaleimide, m-phenylene bismaleimide, Bisphenol A diphenylether bismaleimide which is 2,2′-bis[4-(4-maleimidophenoxy)phenyl]propane, 3,3-dimethyl-5,5-diphenylmethane bismaleimide, 4-methyl-1,3-phenylene bismaleimide, or 1,6-bismaleimide-(2,2,4-trimethyl)hexane. A multifunctional maleimide compound, such as phenylmethane maleimide, can be used. The number of the maleimide groups in the maleimide compound is preferred to be 2 to 5 (inclusive).

The base resin preferably contains at least a bismaleimide compound having two maleimide groups in a molecule. More preferably, the base resin contains bismaleimide compounds as the primary constituent of the meleimide compounds. In this case, since the softening temperature is comparatively low, the compatibility of the base resin and the curing agent with each other can further be increased.

The epoxy compound is preferred to have two or more epoxy groups in a molecule. In this case, the epoxy compound can be cured without using other materials. In the following examples of the epoxy compounds, epoxy resin is a generic term referring to compounds having two or more epoxy groups in a molecule. As the epoxy compounds, there can be used Bisphenol type epoxy resin, aromatic multifunctional epoxy resin, phenolic multifunctional epoxy resin, naphthalene type epoxy resin, or epoxy resins having alicyclic skeletons produced by hydrogenating benzene rings of these epoxy resins. Bisphenol type epoxy resins can include, for example, Bisphenol A type, Bisphenol F type, or the like. The aromatic multifunctional epoxy resins can include, for example, glycidylamine type or the like. The phenolic multifunctional epoxy resins can include, for example, phenol novolac type, cresol novolac type, or the like. The naphthalene type epoxy resins can include, for example, a bifunctional epoxy resin, such as EPICLON HP-4032D manufactured by DIC corporation, a tetrafunctional epoxy resin, such as EPICLON HP-4700 manufactured by DIC corporation, or the like. Aside from these, as the epoxy compounds, there can be used, for example, epoxy resins having aliphatic skeletons such as trimethylolpropane or ethylene glycol.

Of these, as the epoxy compounds, it is preferred to use epoxy resins having aromatic rings, such as Bisphenol A type, glycidylamine type, phenol novolac type, cresol novolac type, and naphthalene type. In this case, the cured product has improved mechanical characteristics and glass transition temperature. In view of improving mechanical characteristics and glass transition temperature, as the epoxy compounds, epoxy resins of cresol novolac type and naphthalene type are more preferred. In view of further improving glass transition temperature, as the epoxy compounds, naphthalene type epoxy resins are especially preferred.

The base resin is preferred to contain at least a maleimide compound. In this case, heat resistance of the cured product (sealing resin) is improved well. As a result, the electrical component is suitable for use under high temperature environments. When the maleimide compounds and the epoxy compounds are used in combination, it is preferred that the epoxy compound content is 30 mass parts or less to the sum of both compounds as 100 mass parts.

The curing agent is preferred to contain an aromatic polyamine. The aromatic polyamine is an aromatic compound having two or more amino groups. As the aromatic polyamine, for example, an aromatic diamine such as diaminodiphenyl sulfone (DDS), diaminodiphenyl methane (DDM), or the like can be used. As the aromatic polyamines, for example, polyamines having phenylene oxide skeletons and polyamines having phenylenesulfide skeletons can be used.

The sealing resin is preferred to be made of a cured product of a molding material containing the foregoing base resin and the curing agent containing the diamine compound represented by the following chemical formula (2). In this case, the sealing resin has a similar structure to the structure of the primer layer represented by the foregoing chemical formula (1). Accordingly, affinity between the sealing resin and the primer layer can further be improved. Further, in this case, due to having a phenylene oxide skeleton which has excellent adhesiveness, the sealing resin can show excellent adhesiveness. Further, in this case, toughness of the sealing resin is improved. The reason is considered to be the strong interaction between the maleimide sites, between the epoxy sites, or between the maleimide site and the epoxy site in the sealing resin, and strong interaction caused by the main skeletons of the diamine compound arranging in a plane in the cured product.

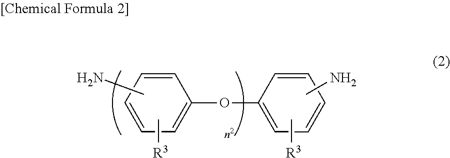

(In the chemical formula (2), R³ is H or 1-3C alkyl group, n² is an integer of 1 to 10 (inclusive).)

In the chemical formula (2), amino group and R³ may occupy any position of the benzene ring. That is, amino group and R³ may occupy any position of ortho positions, meta positions and para positions. As the curing agents, of the compounds represented by the chemical formula (2), one, two or more types of compounds can be used.

The benzene rings in the chemical formula (2) are preferred to bind via O atoms at ortho positions or para positions relative to each other. In this case, toughness of the sealing resin is further improved. The reason is considered to be that steric barriers in the resin structure are reduced, which makes it easier that the benzene rings arrange in a plane. More preferably, all the benzene rings in the chemical formula (2) bind via O atoms at para positions relative to each other. Also, the amino group of the end in the chemical formula (2) is preferred to occupy para positions relative to O atoms.

If n² in the chemical formula (2) is too large, it is anticipated that not only synthesis of the diamine compound becomes difficult, but also the melting point of the diamine compound becomes high. In view of that, n² in the chemical formula (2) is preferred to be 1 to 10 (inclusive), as described above, more preferably 1 to 5 (inclusive), and further preferably 1 to 3 (inclusive). As the compounds represented by the chemical formula (2), there can be used one selected from the compounds of n² within a range of 1 to 10 (inclusive). Mixture of two or more compounds wherein n² are different from each other may be used.

As the curing agents, phenol-based curing agent can be used. As the phenol-based curing agents, for example, phenol novolac, cresol novolac, novolacs having Bisphenol A skeletons, or the like can be used. As the phenol-based curing agent, it is preferred that, for example, equivalence of phenolic OH is 120 or less and softening point or melting point is 130° C. or less. More preferably, equivalence of phenolic OH is 90 or less and softening point or melting point is 100° C. or less. It should be noted that the equivalence of phenolic OH means equivalence of the hydroxyl groups binding to the benzene rings.

If commercial items are used as the phenol-based curing agent, information on the equivalence of phenolic OH is provided by the manufacturer. The equivalence of phenolic OH can be measured, for example, as follows. Specifically, at first, the phenolic curing agent is added to a mixture solution of pyridine and acetic anhydride. At this time, an acetylated product is produced from the phenol-based curing agent. The acetylated product is back-titrated with alkali, and thereby the equivalence of phenolic OH can be measured. The softening point or melting point of phenols can be regulated by adjusting skeleton structure of phenols or using a mixture of phenols. The softening point can be measured by, for example, a ring and ball method.

The molding material is preferred to further contain a curing catalyst. This can advance curing of the molding material. As the curing catalysts, commercial products for curing reactions of maleimide resin and/or epoxy resin can be used. As the curing agent, for example, phosphorus-based catalysts, amine-based catalysts or the like can be used. More specifically as the phosphorus-based catalyst, for example, triphenylphosphine, salt thereof, or the like can be used. As the amine-based catalyst, for example, alkylimidazoles, imidazoles containing CN groups, carboxylates thereof, or the like are used. Also, as the amine-based catalyst, for example, triazine-modified imidazoles, isocyanuric acid adducts, imidazoles containing hydroxyl groups, or the like can be used.

The alkylimidazoles can include, for example, 2-methylimidazole, 2-phenylimidazole, or the like. The imidazoles containing CN can include, for example, 1-cyanoethyl-2-methylimidazole, or the like. The triazine-modified imidazoles can include, for example, 2,4-diamino -6[2′-methylimidazolyl-(1′)]-ethyl -s-triazine, or the like. The imidazoles containing hydroxyl groups can include, for example, 2-phenyl-4,5-dihydroxymethylimidazole, or the like. As the amine-based catalyst, aside from these, there can be used 2,3-dihydro-1H-pyrrolo[1,2-a] benzimidazole, 1-dodecyl-2-methyl-3-benzylimidazolium chloride, 2-methylimidazoline, 2-phenylimidazoline, or the like. Of these, as the curing catalyst, imidazoles are preferred. In this case, curing speed of the molding material can be improved.

In order to adjust the linear expansion coefficient of the cured product, the molding material can further contain fillers such as silica or alumina. In this case, the sealing material can further be prevented from peeling. The filler content in total mass of the molding material is preferred to be 60 to 95 mass % (inclusive), more preferably 65 to 90 mass % (inclusive), and further preferably 70 to 85 mass % (inclusive). Specifically, the filler content can be adjusted properly such that the linear expansion coefficient becomes a desired value.

The molding material can further contain an adhesive aid. In this case, adhesiveness of the sealing resin can further be improved. As the adhesive aid, for example, silane compounds or the like are used. The silane compounds can include, for example, glycidoxypropyltrimethoxysilane, aminopropyltrimethoxysilane, or the like.

The primer layer contains polyimide polymer having the polyimide skeleton whose structure is represented by the chemical formula (1). In the chemical formula (1), R¹ is a tetravalent alicyclic hydrocarbon group, tetravalent aliphatic hydrocarbon group, or tetravalent aromatic hydrocarbon group, and may contain O or/and S. More specifically R¹ may have at least one functional group or bond selected from a sulfide bond, sulphonyl group, ether bond, ester bond, and carbonate group.

In the chemical formula (1), R² is H or a 1-3C alkyl group. If the carbon number of R² is too large, the steric hindrance in the polyimide skeleton is large, which might decrease affinity between the primer layer and the sealing resin. In the formula (1), n¹ is an integer from 1 to 10 (inclusive), and m is an integer from 1 to 100000 (inclusive). If n¹ and m are too large, synthesis of polyimide polymer might become difficult. n¹ is preferred to be 1 to 5 (inclusive), and further preferably 1 to 3 (inclusive). The polyimide polymer only has to have at least the structure represented by the formula (1), and may partially have a polyimide skeleton having a structure other than the structure of the formula (1).

The primer layer can be formed by coating the electrical component with a primer solution containing polyamic acid and heating. Heating causes dehydration and a ring closure reaction (imidization) of polyamic acid, and thereby the structure represented by the formula (1) can be formed.

Polyamic acid can be obtained by polymerizing an anhydride and a diamine compound. Specifically, a mixture solution of diamine compound, anhydride and a solvent is prepared to react the diamine compound and anhydride in the mixture solvent, thereby obtaining the primer solution containing polyamic acid. The polyamic acid content in the primer solution is preferred to be 2 to 50 mass % (inclusive), more preferably 3 to 40 mass % (inclusive), and further 10 to 25 mass % (inclusive). If the polyamic acid content is too small, there is a need for repeatedly coating in the process of forming the primer layer, which might make the process complicated. On the other hand, if the polyamic content is too large, viscosity of the primer solution becomes large, which might make coating difficult. The formulation ratio of diamine compound and anhydride can be adjusted properly on the basis of the equivalent ratio of functional groups of both substances. Specifically, the formulation ratio can be adjusted properly such that the equivalent ratio of functional groups of both substances is, for example, 0.5 to 1.5 (inclusive), preferably 0.8 to 1.2 (inclusive), more preferably 0.9 to 1.1 (inclusive). The equivalent ratio is most preferably 1, respectively.

As the anhydride, bifunctional anhydrides are preferred. As the anhydride, for example, a diphenylsulfone type, ethylene glycol type, or the like can be used. As the diamine compound, it is preferred that at least the compound represented by the following chemical formula (3) is used.

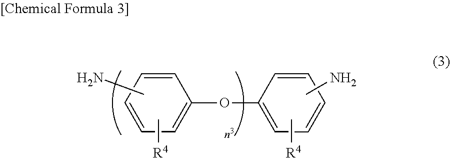

(In the formula (3), R⁴ is H or a 1-3C alkyl group, and n³ is an integer from 1 to 10 (inclusive).)

It is preferred that the compound represented by the formula (2) and the compound represented by the formula (3) are the same. In this case, the sealing resin and the primer layer have the same structure in the skeleton. Accordingly, affinity between the sealing resin and the primer layer is further improved. Therefore, occurrence of peeling is prevented in a wide temperature region more reliably.

The polyamic acid is preferred to have the structure represented by the following chemical formula (4). In this case, the primer layer containing polyimide polymer having the structure represented by the formula (1) can be formed readily by heating or the like.

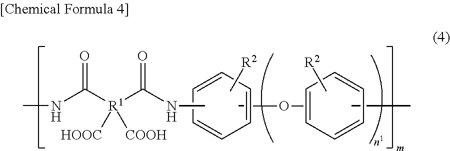

(In the formula (4), R¹, n¹, m are the same as the formula (1).)

### EXAMPLES

### Example 1

Now is described an example of the electrical component.

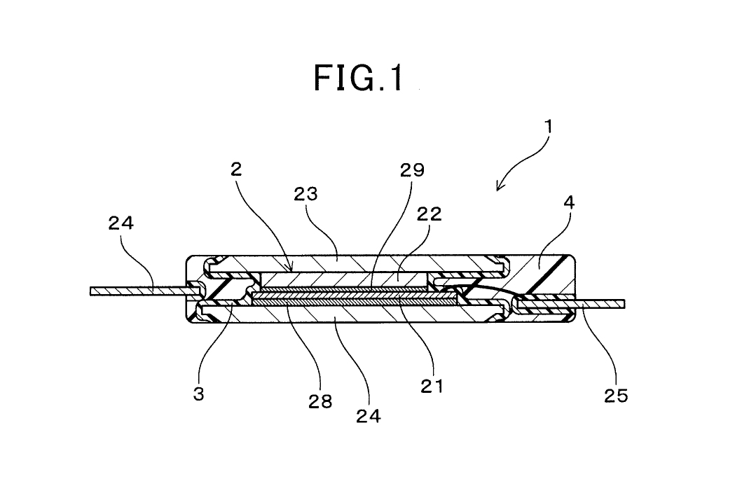

As shown in FIG. 1, the electrical component 1 of this example has the electronic part 2, the primer layer 3 and the sealing resin 4. The primer layer 3 at least partially covers the electronic part 2. The sealing resin 4 at least partially covers the primer layer 3 and the electronic part 2.

As shown in FIG. 1, the electrical component of this example is a semiconductor module (power card) used in a power control unit for a hybrid vehicle. In the electrical component 1, a power device (power element) 21, a copper spacer 22 and copper plates for heat radiation 23 and 24 are soldered by a reflow method to configure the electronic part 2. The electronic part 2 and electrode terminals 25 and 26 are sealed with the sealing resin 4. In FIG. 1, a region between the power device 21 and the copper spacer 22, and another region between the power device 21 and the copper plate 24 are joint portions 28 and 29 made of solder. The primer layer 3 is provided between the electronic part 2 and the sealing resin 4.

The primer layer 3 contains polyimide polymer having the predetermined structure. Specifically, the polyimide polymer has the structure represented by the following chemical formula (5).

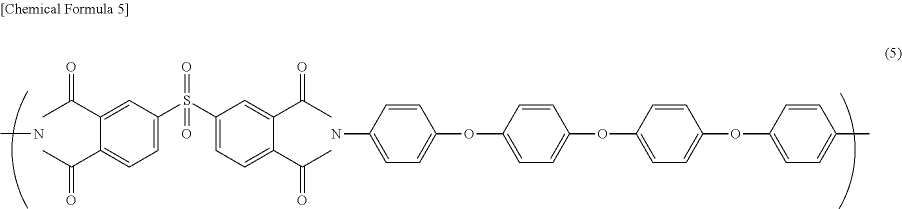

The primer layer 3 represented by the formula (5) is obtained using polyamic acid having the structure represented by the following chemical formula (6).

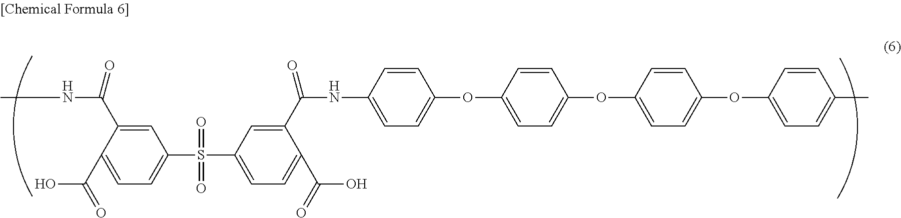

Polyamic acid represented by the formula (6) is obtained by polymerizing the diamine compound having a phenylene oxide skeleton represented by polymerizing the formula (7) and anhydride of diphenylsulfone type represented by the formula (8).

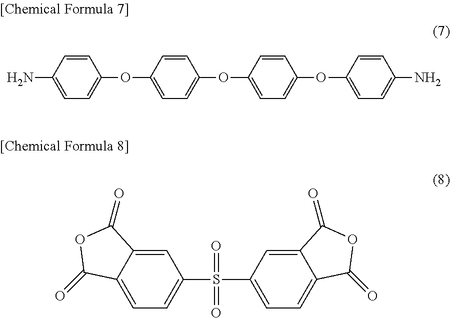 [SMILES: Nc1ccc(Oc2ccc(Oc3ccc(Oc4ccc(N)cc4)cc3)cc2)cc1 ; O=C1OC(=O)c2cc(S(=O)(=O)c3ccc4c(c3)C(=O)OC4=O)ccc21]

The sealing resin 4 contains maleimide-based resin, and is made of a cured product of a molding material containing a base resin and a curing agent. The base resin contains maleimide compound, and the curing agent contains the diamine compound having the phenylene oxide skeleton represented by the formula (7). The sealing resin 4 contains silica as filler.

Hereinafter is described a method for preparing the electrical component of this example.

At first, the diamine compound used as the raw material of the polyamic acid and the curing agent of the sealing resin is synthesized as follows. Specifically, firstly, 4,4′-dihydroxydiphenyl ether and p-chloronitrobenzene were mixed into N,N′-dimethylacetoamide as a reaction solvent with a ratio of OH:Cl=1:1.1 in equivalence ratio. Subsequently, the temperature of the reaction solvent was increased to 80° C. Thereafter, potassium carbonate was added to the reaction solvent with the equivalent ratio of hydroxyl groups of 4,4′-dihydroxydiphenyl ether and potassium carbonate such that OH:potassium carbonate=1:1.1.

Next, the reaction solvent was heated at a temperature of 125° C. for five hours to perform reaction. Thereafter, the reaction solution was introduced to ion-exchanged water for reprecipitation, and was filtered, thereby obtaining a solid. The solid was washed with hot methanol, followed by obtaining the washed solid by filtering. The obtained solid was dried, thereby obtaining phenylene ether oligomer (n=3) having nitro groups at both ends. The yield of phenylene ether oligomer was 90%.

Next, as a reaction solvent, a mixture solvent of isopropyl alcohol and tetrahydrofuran was prepared. Palladium carbon and phenylene ether oligomer having nitro groups at both ends which was prepared as described above were added to the reaction solvent. The formulation ratio of phenylene ether oligomer and palladium carbon was 1:0.05 (phenylene ether oligomer:palladium carbon) in mass ratio.

Subsequently, after the temperature of the reaction solvent was increased to 55° C., hydrated hydrazine was formulated to the reaction solvent spending an hour. The formulation amount of hydrated hydrazine was adjusted such that the equivalent ratio of nitro groups of phenylene ether oligomer and hydrated hydrazine was 1:4 (nitro group: hydrated hydrazine). Thereafter, the reaction solvent was heated to perform reaction for five hours at 60° C., thereby reducing nitro groups at both ends of the phenylene ether oligomer to amino groups. Subsequently, palladium carbon was removed from the reaction solvent by hot filtration, followed by performing vacuum concentration to evaporate the solvent such that 2/3 of the volume of the solvent before the vacuum concentration was removed. Next, the same amount (volume) of isopropyl alcohol as the amount of the removed solvent was added to the remained solvent, followed by increasing the temperature to 80° C. Thereafter, a solid was precipitated by cooling the solvent.

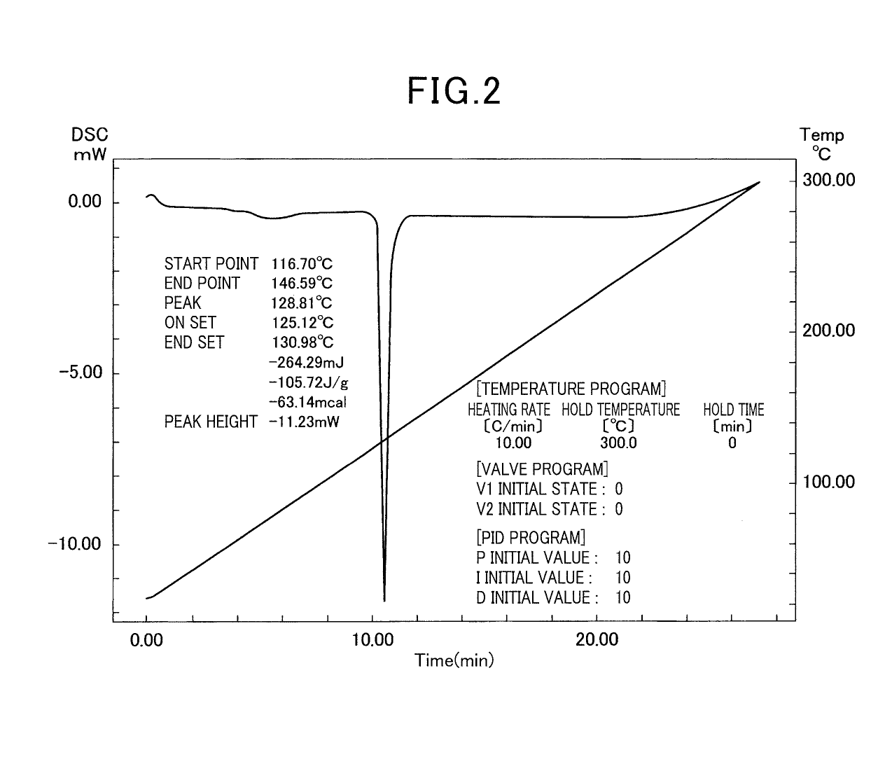

Subsequently, the solid was obtained by filtering, followed by drying. Thereafter, phenylene ether oligomer (n=3) having amino groups at both ends, i.e. the diamine compound (molecular weight 384) represented by the formula (7) was obtained. The yield was 85%. Differential scanning calorimetry (DSC) of the obtained diamine compound was performed by using differential scanning calorimeter EXSTAR6000 manufactured by SII nanotechnology, Inc. As a result, in the obtained diamine compound, a sharp peak at the vicinity of 126° C. showing the melting point of the target substance was confirmed. For reference, the result is shown in FIG. 2. FIG. 2 shows the relation between DSC curve and time, and the relation between temperature and time. In FIG. 2, the vertical axis on the left side shows heat flow (mW), the horizontal axis shows time (minute), and the vertical axis on the right shows temperature (° C.). In FIG. 2, the measurement conditions for DSC are described. Although illustration is omitted, the structure of obtained diamine compound was checked by nuclear magnetic resonance (NMR) measurement, and purity of the obtained compound was checked by high performance liquid chromatography (HPLC).

Next, 5 g of the diamine compound obtained as above, 4.7 g of bifunctional anhydride (see the formula (8), molecular weight 358) of diphenylsulfone type which has the same equivalence as the diamine compound, and 90.3 g of a solvent were mixed, and the mixture was stirred for an hour at room temperature. Thus, the primer solution which was polyamic acid solution of solid content of 10 mass % was obtained. As the solvent, N-methyl-pyrrolidone (NMP) was used.

Subsequently, the electronic part 2 was coated with the primer solution, and was heated for three hours at 290° C. Thus the primer layer 3 was formed on the electronic part 2 (see FIG. 1). As shown in FIG. 1, the primer layer 3 was formed between the electronic part 2 and the sealing resin 4 such that as the electronic part 2 and the sealing resin 4 do not contact directly each other.

Next, the molding material was prepared. Specifically, at first, as the maleimide compound, phenylmethane type bismaleimide (BMI-2300 produced by Daiwa Kasei Industry Co., Ltd., maleimide equivalence 179) was prepared. As the curing agent, the diamine compound represented by the formula (7) was used. As the adhesive aid, glycidoxypropyltrimethoxysilane was prepared. As the curing catalyst, 2PZ was used which was 2-phenylimidazole produced by SHIKOKU CHEMICALS CORPORATION. As the filler (spherical silica), RD-8 produced by TATSUMORI, Ltd. was prepared. These maleimide compound, diamine compound, adhesive aid, curing catalyst and filler were fed into an open roll type mixer (produced by Toyo Seiki Seisaku-Sho, Ltd.) which had been heated at 120° C., and mixed for five minutes. The formulation amount of the filler was 78 mass % in the total mass of the raw materials. Thus, the molding material was obtained.

Next, the electronic part having the primer layer thereon was set in a die, and the molding material was transfer-molded in the die. Thus, the molding material was molded and cured, thereby obtaining the electrical component 1 as shown in FIG. 1. The composition of the primer solution used for preparing the electrical component, and the types of the base resin and curing agent in the molding material are shown in Table 1, below.

### Examples 2 to 11 and Comparative Examples 1 and 2

Next, a plurality of electrical components different in composition of the primer layer and the sealing resin from Example 1 were prepared. Although illustration is omitted, each electrical component had the same configurations as Example 1 except for the composition (see FIG. 1). The electrical components of Examples 2 and 3 were prepared in a similar manner to Example 1 except for using the primer solution different in formulation ratio of the diamine compound and the anhydride from Example 1. The composition of the primer solution used for preparing Examples 2 and 3 was shown in Table 1, below.

The electrical component of Example 4 was prepared in a similar manner to Example 1 except for using ethylene glycol type anhydride. Specifically, as the anhydride, a bifunctional anhydride (molecular weight 410) of ethylene glycol type represented by the following chemical formula (9) was used. The composition of the primer solution used for preparing Example 4 is shown in Table 1, below.

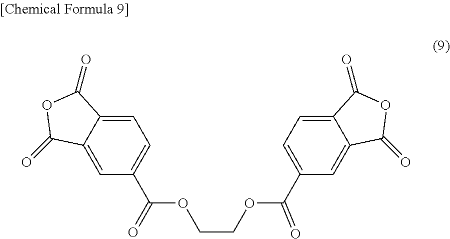 [SMILES: O=C(OCCOC(=O)c1ccc2c(c1)C(=O)OC2=O)c1ccc2c(c1)C(=O)OC2=O]

In Example 4, a polyamic acid having the structure represented by the formula (10) is obtained from an anhydride represented by the formula (9) and a diamine compound represented by the formula (7). Since the polyamic acid represented by the formula (10) is used, the primer layer of Example 4 has the structure represented by the following chemical formula (11).

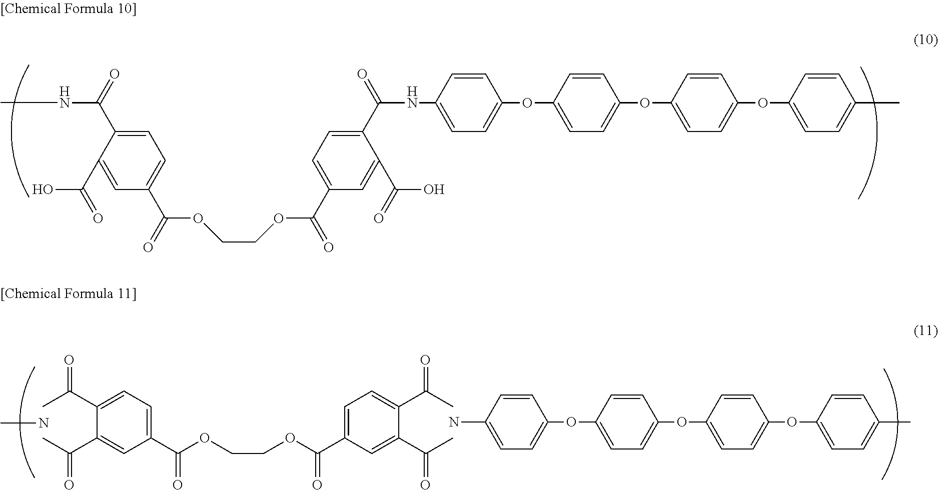

In the electrical components of Examples 5 to 7, the sealing resin contains epoxy-based resin (no maleimide resin). The electrical component of Example 5 was prepared in a similar manner to Example 1 except for using the molding material containing Bisphenol A type epoxy compound as the base resin. The electrical component of Example 6 was prepared in a similar manner to Example 1 except for using the molding material containing cresol novolac type epoxy compound as the base resin and phenol novolac type curing agent as the curing agent. The electrical component of Example 7 was prepared in a similar manner to Example 1 except for using the molding material containing Bisphenol A type epoxy compound as the base resin and phenol novolac type curing agent as the curing agent.

The electrical components of Examples 8 to 11 were prepared using, as the diamine compound used in the primer solution, a diamine compound having the phenylene oxide skeleton represented by formula (7) and hexamethylenediamine (molecular weight 116) in combination. That is, in the electrical component of Examples 8 to 11, the primer layer contains copolymer where the structure represented by the formula (5) and the structure represented by the following chemical formula (12) are polymerized at random.

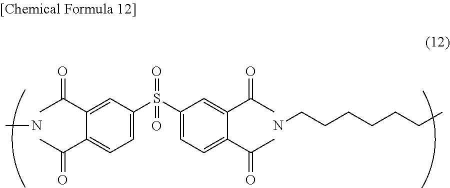

The electrical components of Examples 8, 10 and 11 were prepared in a similar manner to Example 1 except for using each primer solution having the composition shown in Table 1 below. The electrical component of Example 9 was prepared in a similar manner to Example 1 except for using the primer solution having the composition shown in Table 1 and the molding material containing Bisphenol A type epoxy compound as the base resin.

In the electrical component of Comparative Examples 1 and 2, the primer layers do not have the structure represented by the formula (5), and consist of polyimide polymer having the structure of the formula (12). The electrical component of Comparative Example 1 was prepared in a similar manner to Example 1 except for using a primer solution containing hexamethylene diamine in place of the diamine compound having a phenylene oxide skeleton. The electrical component of Comparative Example 2 was prepared in a similar manner to Example 1 except for using a primer solution containing hexamethylene diamine in place of the diamine compound having a phenylene oxide skeleton, and using the molding material containing Bisphenol A type epoxy compound as the base resin. In Comparative Examples 1 and 2, a polyamic acid having the structure shown in the following chemical formula (13) is obtained from the anhydride represented by the formula (8) and hexamethylene diamine. The primer layer having the structure shown in formula (12) is formed by using the primer solution containing polyamic acid.

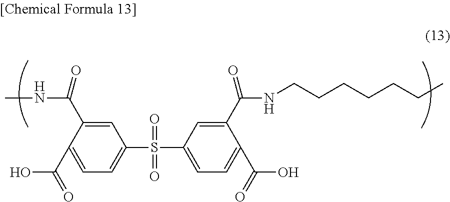

In the each Example and Comparative Example, as a Bisphenol A type epoxy compound, DER331J produced by Dow Chemical Japan was used. As the cresol novolac type epoxy compound, EOCN-1035 produced by Nippon Kayaku Co., Ltd. was used. As the phenol novolac type curing agent, PHENOLITE TD-2131 produced by DIC was used.

### Experimental Example

Next, durability of the electrical component of Examples and Comparative Examples were evaluated. Durability was evaluated by thermal shock test. Specifically, at first, a cooling/heating cycle where each electrical component was heated at a temperature of 250° C. for 30 minutes and subsequently kept for 30 minutes at a temperature of −40° C. was repeated. The occurrence of internal peeling of the sealing resin in the electrical component was checked at a certain intervals using ultrasonic test equipment. A case where there was no peeling after 1000 or more cycles of the thermal shock test was evaluated as excellent (labeled ‘OO’). A case where no peeling occurred during not less than 100 and less than 1000 cycles of the thermal shock test but peeling occurred after 1000 cycles was evaluated as good (labeled ‘O’). A case where peeling occurred during less than 100 cycles of the thermal shock test was evaluated as rejected (labeled ‘X’). The results of the thermal shock test of Examples and Comparative Examples are shown in Table 1.

TABLE 1

| | | | Example & Comparative Example No. | | | | | | | | | | | | |
|---|---|---|---|---|---|---|---|---|---|---|---|---|---|---|---|
| | | | | | | | | | | | | | | Comparative | |
| | | | Example | | | | | | | | | | | Example | |
| | | | 1 | 2 | 3 | 4 | 5 | 6 | 7 | 8 | 9 | 10 | 11 | 1 | 2 |
| A | Diamine | Phenylene oxide | 5 | 2 | 20 | 5 | 5 | 5 | 5 | 4 | 4 | 2 | 1 | — | — |
| (mass %) | Compound | skeleton diamine | | | | | | | | | | | | | |
| | | Hexamethylene | — | — | — | — | — | — | — | 1 | 1 | 3 | 4 | 5 | 5 |
| | | Diamine | | | | | | | | | | | | | |
| | Anhydride | Diphenylsulfone | 4.7 | 1.9 | 18.6 | | 4.7 | 4.7 | 4.7 | 6.8 | 6.8 | 11.1 | 13.3 | 15.4 | 15.4 |
| | | Type | | | | | | | | | | | | | |
| | | Ethyleneglycol | — | — | — | 5.3 | — | — | — | — | — | — | — | — | — |
| | | Type | | | | | | | | | | | | | |
| | Solvent | N-methyl- | 90.3 | 96.1 | 61.4 | 89.7 | 90.3 | 90.3 | 90.3 | 88.2 | 88.2 | 83.9 | 81.7 | 79.6 | 79.6 |
| | | 2-pyrrolidone | | | | | | | | | | | | | |

| | | | | | | | | | | | | | | |
|---|---|---|---|---|---|---|---|---|---|---|---|---|---|---|
| B | Base resin | BM | BM | BM | BM | BE | CE | BE | BM | BE | BM | BM | BM | BE |
| | Curing Agent | PD | PD | PD | PD | PD | PN | PN | PD | PD | PD | PD | PD | PD |

| | | | | | | | | | | | | | |
|---|---|---|---|---|---|---|---|---|---|---|---|---|---|
| Thermal Shock Test | ◯◯ | ◯◯ | ◯◯ | ◯◯ | ◯ | ◯ | ◯ | ◯◯ | ◯ | ◯◯ | ◯ | X | X |

In Table 1, A is primer solution, B is Molding material, BM is bismaleimide, BE is Bishenol A type epoxy, CE is cresol novolac type epoxy, PD is phenylene oxide skeleton diamine, and PN is phenol novolac type.

As shown in Table 1, regarding the electrical components (Examples 1 to 11) having the primer layer containing polyimide polymer, there was no peeling after 100 cycles of the thermal shock test, accordingly excellent durability was confirmed. On the other hand, regarding the electrical components (Comparative Examples 1 and 2) having the primer layers consisting of polyimide polymer having the structure shown in the formula (12), peeling occurred during less than 100 cycles.

From the results of Examples 1 to 11, it is confirmed that the primer layer containing the polyimide polymer having the structure of the formula (1) shows strong affinity with the sealing resin containing epoxy-based resin and/or maleimide-based resin, and this improves durability of the electrical component. Accordingly, combination of the primer layer and the sealing resin can realize an electrical component having excellent durability, as described above.

In the formula (1), as Examples 1 to 11, it is preferred that R¹ is H and n¹ equals 3. In this case, the polyamic acid for obtaining polyimide polymer having the structure shown in the formula (1) can be synthesized readily. Further, in this case, steric hindrance in the structure shown in the formula (1) is reduced. This can further improve affinity between the primer layer and the sealing layer.

As Examples 1 to 5 and Examples 8 to 11, the sealing resin is preferred to be made of the cured product of the molding material containing the base resin and the curing agent, the base resin containing epoxy compound and/or maleimide compound, the curing agent containing the diamine compound represented by the formula (2). In this case, the primer layer and the sealing resin have a similar structure (phenylene oxide skeleton structure) (see the formula (1) and (2)). This further improves affinity between the primer layer and the sealing resin, and thereby durability of the electrical component can further be improved. Further, as Examples 1 to 5 and Examples 8 to 11, it is preferred that R³ of the formula (2) and R² of the formula (1) are the same. In this case, the primer layer and the sealing resin have partially the same phenylene oxide skeleton. This further improves affinity between the primer layer and the sealing resin, and thereby durability of the electrical component can further be improved.

In the formula (2), it is preferred that R³ is H and n² equals to 2. In this case, steric hindrance in the resin structure of the sealing resin is smaller. Accordingly, toughness of the sealing resin can be increased.

Further, as Examples 1 to 4, Example 8, Example 10 and Example 11, the sealing resin is preferred to contain at least maleimide resin. In this case, heat resistance of the sealing resin is improved, and affinity between the sealing resin and the primer layer are further improved. As a result, durability of the electrical component is further improved. Actually, Table 1 shows the superiority of maleimide-based resin, for example, by comparing Example 1 with Examples 5 to 7 or comparing Example 8 with example 9.

Further, it is preferred that polyimide polymer is produced by imidizing a polyamic acid formed by polymerizing an anhydride and a diamine compound, and that the diamine compound contains 40 mass % or more of the compound shown in the formula (3). In this case, the phenylene oxide skeleton can be formed sufficiently in the primer layer. This further improves affinity between the primer layer and the sealing resin, and thereby durability of the electrical component can further be improved. In fact, Table 1 shows the superiority of using 40 mass % or more of the compound represented by the formula (3), for example, by comparing Examples 8 and 10 with Example 11.

1. An electrical component, comprising:
an electronic part;
a primer layer covering at least partially the electronic part; and
a sealing resin covering at least partially the electronic part and the primer layer, wherein
the primer layer contains polyimide polymer having the structure represented by the following chemical formula (1), and
the sealing resin contains epoxy-based resin and/or maleimide-based resin, 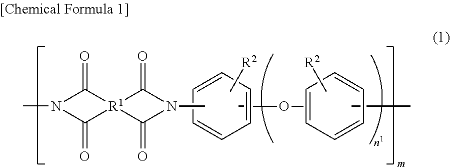
wherein in the formula (1), R¹ is a tetravalent alicyclic hydrocarbon group, tetravalent aliphatic hydrocarbon group, or tetravalent aromatic hydrocarbon group, and may contain O or/and S, and R² is H or a 1-3C alkyl group, n¹ is an integer from 1 to 10 inclusive, and m is an integer from 1 to 100000 inclusive.

2. The electrical component according to claim 1, wherein
in the formula (1), R² is H and n¹ equals to 3.

3. The electrical component according to claim 1, wherein
the sealing resin is made of a cured product of a molding material containing a base resin and a curing agent, the base resin containing an epoxy compound and/or a maleimide compound, the curing agent containing the diamine compound represented by the following chemical formula (2), 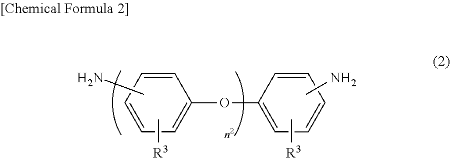
wherein in the formula (2), R¹ is H or 1-3C alkyl group, and n² is an integer from 1 to 10 inclusive.

4. The electrical component according to claim 3, wherein
R³ of the formula (2) and R² of the formula (1) are the same.

5. The electrical component according to claim 3, wherein
in the formula (2), R³ is H and n² equals 3.

6. The electrical component according to claim 1, wherein
the sealing resin contains at least the maleimide-based resin.

7. The electrical component according to claim 1, wherein
the polyimide polymer is formed by imidizing polyamic acid which is formed by polymerizing an anhydride and a diamine compound, and
the diamine compound contains 40 mass % or more of the compound represented by the following chemical formula (3): 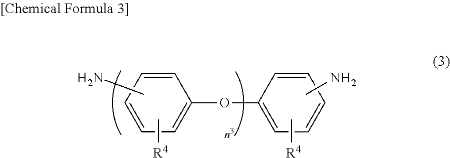
wherein in the formula (3), R⁴ is H or a 1-3C alkyl group, and n³ is an integer from 1 to 10 inclusive.
